(19) United States
(12) Patent Application Publication
(10) Pub. No.: US 2009/0187898 A1
(43) Pub. Date: Jul. 23, 2009

(54) METHOD FOR SECURELY UPDATING AN AUTORUN PROGRAM AND PORTABLE ELECTRONIC ENTITY EXECUTING IT

(75) Inventors: Stephane JAYET, MEYZIEU (FR); Olivier CHAMLEY, LEOGNAN (FR)

Correspondence Address: YOUNG & THOMPSON, 209 Madison Street, Suite 500, ALEXANDRIA, VA, 22314, US

(73) Assignee: OBERTHUR TECHNOLOGIES, Paris (FR)

(21) Appl. No.: 12/249,181

(22) Filed: Oct. 10, 2008

(30) Foreign Application Priority Data
Oct. 10, 2007 (FR) 0758201

(51) Int. Cl. G06F 9/44; H04L 9/00; G06F 15/16; G06F 12/00

(52) U.S. Cl. 717/164; 713/168; 713/176; 709/219; 711/115; 711/E12.001

(57) ABSTRACT

The method for updating an autorun program of a portable electronic entity includes:
a step of connecting said entity to a host station,
a step (250) of executing in said host station a program stored by said entity and adapted to be executed automatically in said host station on connection of said entity to said host station, and
a step (260-285) of secure modification of said program.

The present invention concerns a method for securely updating an autorun program and a portable electronic entity executing it. The term portable electronic entity also covers “pocket” electronic entities. The entity is preferably a USB (Universal Serial Bus) electronic key, i.e. a key whose physical interface with a host station conforms to the USB specification, adapted to communicate according to a protocol conforming to the USB specification. It can also be a microcircuit card of the smart card or flash memory card type.

The document US/2005083741 describes a USB key containing an autorun program. This function is protected by a password or by cryptographic means. However, the above document does not describe any means for modifying the autorun program.

To remedy these drawbacks, a first aspect of the invention is directed to a portable electronic entity including:
means for connecting said entity to a host station,
a memory storing a program adapted to be executed automatically in said host station on connection of said entity to said host station, and
secure means for modifying said program.

Thanks to these features, the autorun program can be modified securely in the portable electronic entity during its service life.

According to particular features, the connection means are adapted to provoke a first enumeration on connection of said entity to said host station, during which said entity is identified and emulates a read-only memory reader containing the file of said program, and the secure means are adapted, in order to modify said program, to provoke stopping of the operation of the entity and to provoke a second enumeration, during which said entity is identified and emulates a rewritable non-volatile memory reader containing the file of said program.

According to particular features, the secure means are adapted, in order to modify said program, to provoke stopping and restarting of the operation of the entity before provoking the second enumeration.

According to particular features, the secure means are adapted to write into a reserved memory area of said entity an instruction provoking the identification of said entity to a rewritable non-volatile memory the next time said entity is started.

Thanks to each of these features, the portable electronic entity of the present invention is compatible with host stations that would not support re-enumeration of the portable electronic entity that is connected to them. Moreover, each of these features simplifies the production of the portable electronic entity of the present invention.

According to particular features, the connection means are adapted to provoke a first enumeration during which said entity is identified as a CD-ROM reader.

According to particular features, the secure means are adapted to provoke a second enumeration during which said entity is identified as a USB flash memory reader.

The present invention therefore applies to USB keys.

According to particular features, the secure means include means for authenticating a modified version of said program.

According to particular features, the secure means include means for verifying a signature of a modified version of said program.

Thanks to these features, the identity of the sender of the update is verified before the update is effected.

According to particular features, the secure means include means for decrypting a modified version of said program.

These features make updating of the program more secure.

According to particular features, the portable electronic entity briefly described above includes a memory area storing a cryptographic key and the secure means for modifying said program use a cryptographic key corresponding to said stored cryptographic key.

Security is therefore particularly strong.

According to particular features, the autorun program includes means for accessing a remote server.

Thanks to these features, updating is effected on a single physical medium.

According to particular features, the portable electronic entity briefly described above includes a physical interface with the host station conforming to the USB specification and is adapted to communicate with the host station using a protocol conforming to the USB specification to obtain modification data of said program.

The present invention therefore applies to USB keys.

A second aspect of the present invention is directed to a method for updating an autorun program of a portable electronic entity, including:
a step of connecting said entity to a host station,
a step of executing in said host station a program stored by said entity and adapted to be executed automatically in said host station on connection of said entity to said host station, and
a step of secure modification of said program.

A third aspect of the present invention is directed to an autorun program of a portable electronic entity including instructions for executing the method of the present invention, as briefly described hereinabove.

The particular advantages, aims and features of this method and this program being similar to those of the portable electronic entity of the present invention, as briefly described hereinabove, they are not repeated here.

Other advantages, aims and features of the present invention will emerge from the following description given by way of nonlimiting explanation and with reference to the appended drawings, in which:

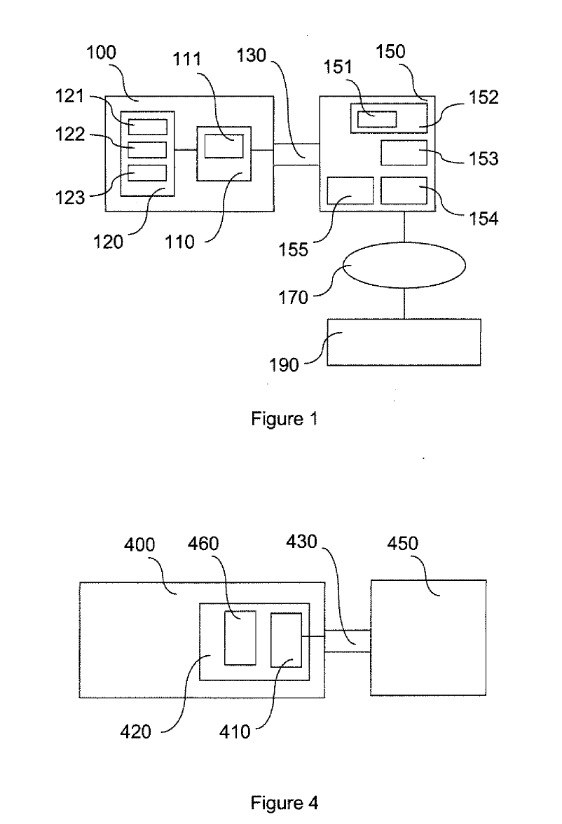

FIG. 1 is a diagram representing a first embodiment of the portable electronic entity of the present invention,

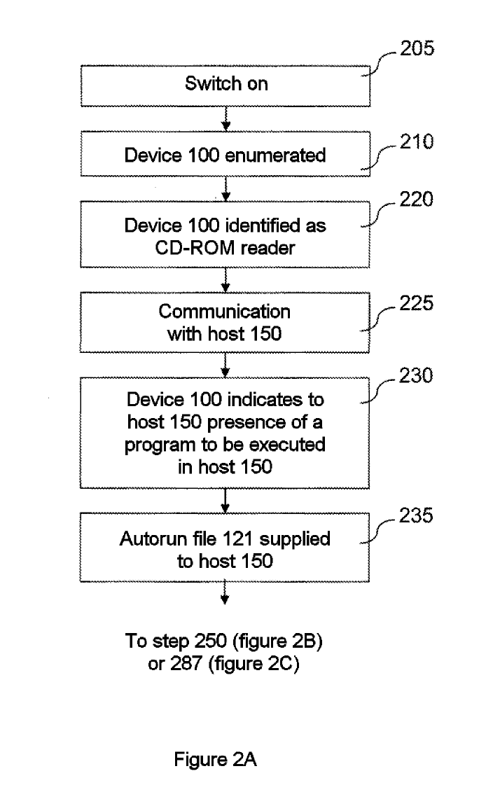

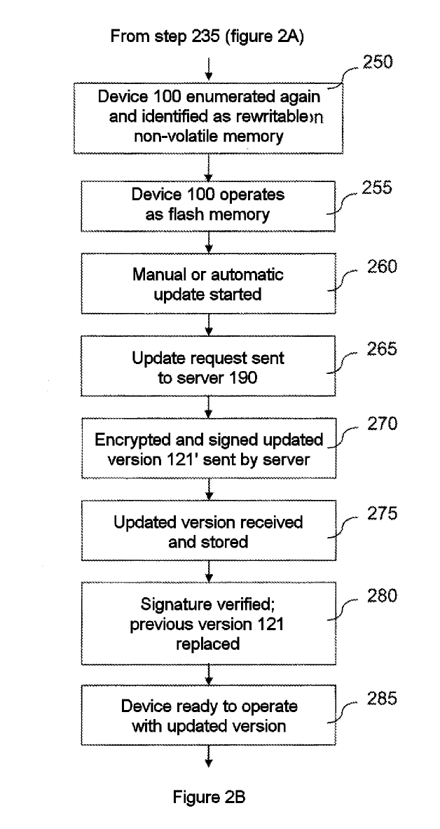

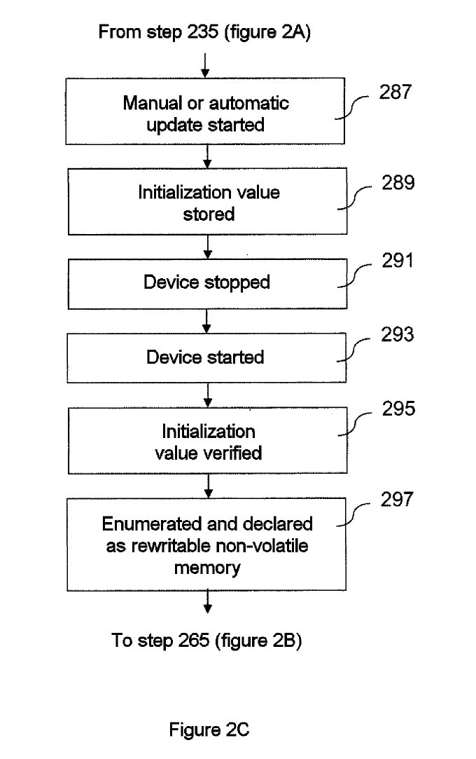

FIGS. 2A and 2B are flowcharts showing steps implementing a first embodiment of the method of the present invention using the entity described with reference to FIG. 1,

FIG. 2C is a flowchart showing steps implementing a second embodiment of the method of the present invention using the entity described with reference to FIG. 1,

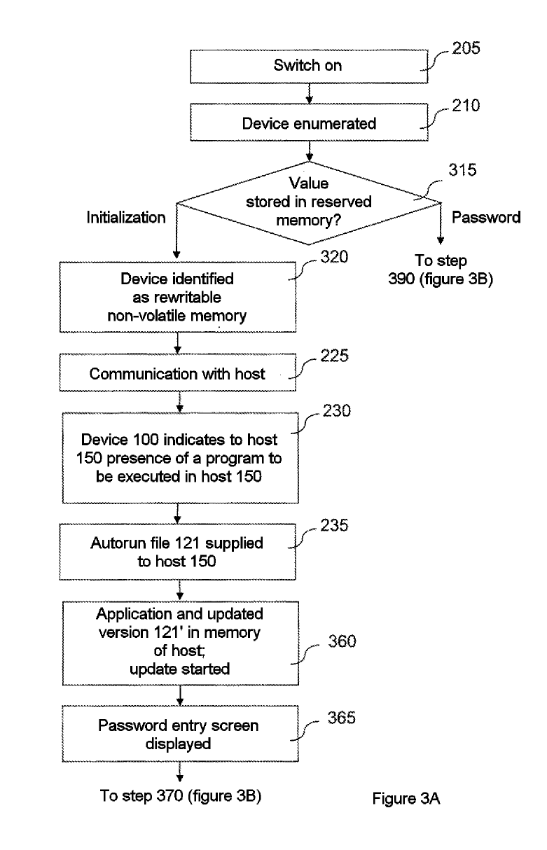

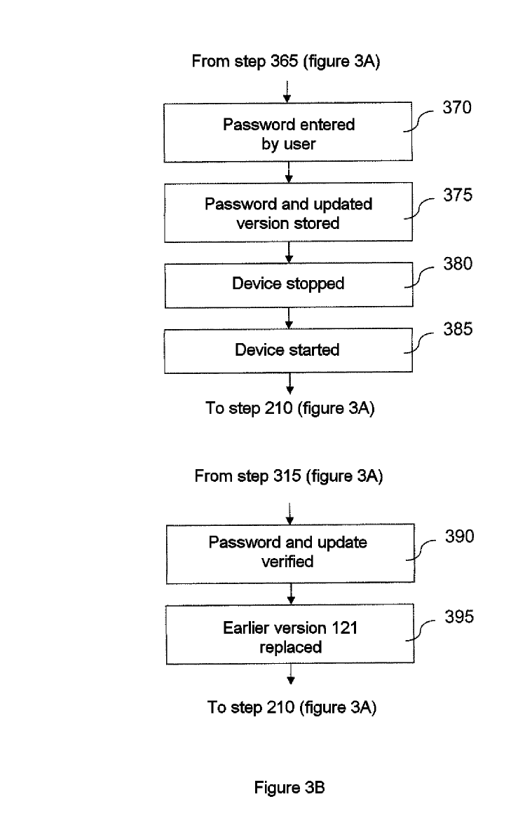

FIGS. 3A and 3B are flowcharts showing steps implementing a third embodiment of the method of the present invention using the entity described with reference to FIG. 1, and

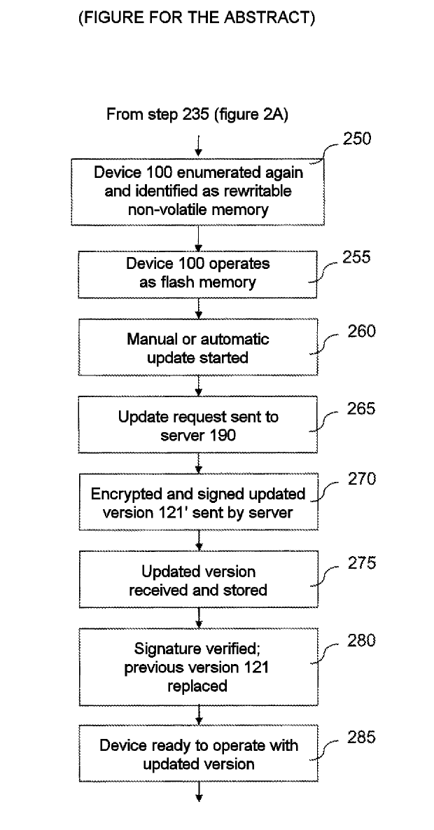

FIG. 4 is a diagram representing a second embodiment of the portable electronic entity of the present invention.

Throughout the description the terms “encrypt” and “encipher” are used interchangeably, as are the terms “decrypt” and “decipher”.

Throughout the description, the terms “portable electronic entity”, “device” and “peripheral” are used interchangeably to designate the portable electronic entity of the present invention.

FIG. 1 shows a portable electronic entity 100, a host station 150, a telecommunication network 170 and a remote station 190. Here the portable electronic entity 100 is a USB key. In other embodiments of the present invention (not shown) the portable electronic entity implementing the present invention is a memory card or an SIM (Subscriber Identification Module) card.

The host station 150 is a personal computer or a mobile telephone, for example. The host station 150 includes a memory 152, a processor unit 153, a screen 154 and a keyboard 155. The telecommunication network 170 is the Internet, for example, or a mobile telecommunication network. The remote station 190 is a server, for example.

The portable electronic entity 100 includes an interface 130 with the host station 150, here a USB interface, i.e. one implementing the USB protocol, and a controller 110 of a rewritable non-volatile memory 120. The USB interface 130 is used in particular to obtain data for modifying the program 121 described later. The controller 110 includes a rewritable non-volatile memory storing a control program 111 for the controller 110. Each of these rewritable non-volatile memories is an EEPROM (electrically-erasable programmable read-only memory) or EPROM (erasable programmable read-only memory), for example.

The memory 120 stores an autorun program 121. A memory 122 cannot be read from outside the entity and contains a cryptographic key K2 and a memory 123 is reserved for initialization data and/or passwords intended for the control program 121. The autorun program 121 stored in the memory 122 is encrypted by the key K2.

The computer program of the present invention can be embedded in a memory of various configurations of devices to provide a wide variety of USB peripherals with autorun functions that can be updated. For example, the device includes a “hub” through which a microcontroller communicates with a rewritable non-volatile internal memory component containing said autorun program. To give another example, the device includes a USB microcontroller connected to a rewritable non-volatile external memory component via a downstream port. The autorun program can be stored in the memory of the microcontroller or in an internal memory component, FIG. 1 representing the latter option.

In a different configuration, the device of the present invention forms a USB peripheral that has multiple functions. This USB peripheral includes, on the one hand, an internal microprocessor with a USB interface and, on the other hand, a rewritable non-volatile memory component and a wireless communication device, for example conforming to the Bluetooth standard, the ISO 14443 standard or the NFC standard. The peripheral is therefore capable of communicating with a wireless communication device such as a “dongle” or a USB flash memory, each of these functions being accessible or configurable by means of the autorun program.

A dongle is a hardware component that is connected to a computer, generally via an input-output port. In the 1980s, this term designated hardware for validating the right to use software, having the “hardware lock” role. At present, this term can designate all kinds of hardware such as storage peripherals (USB keys), keys for connecting to a Wi-Fi, Bluetooth or infrared network, and keys for receiving terrestrial digital television.

As can be seen in FIGS. 2A and 2B, the flowchart of a first embodiment of the method of the present invention includes a step 205 in which a peripheral 100 is inserted in or connected to a USB port of a host station 150, for example a personal computer.

In a step 210, the host station 150 effects an enumeration to identify newly connected USB peripherals. Here the term “enumeration” refers to a USB process whereby the system identifies and configures the peripheral, assigning it a unique address. This is a process for dynamic management of the connection and disconnection of peripherals connected to a USB bus. This enumeration phase occurs each time a peripheral is connected. During this phase, the controller 110, in conjunction with the control program 111, supplies the host with a series of descriptors enabling it to be identified completely. The host assigns a unique address to the peripheral (dynamic addressing) and configures the peripheral.

In a step 220, the control program 111 of the USB peripheral announces itself with a device interface description. For example, the device interface description includes a mass storage class that is transparent for the SCSI (Small Computer System Interface) instruction set.

In the first embodiment, in the step 220, the controller 110 running the control program 111 describes the peripheral 100 as a CD-ROM (compact disc-read only memory) reader, describing a bulk only transport class corresponding to a CD-ROM, and emulates the operation of this kind of reader.

In a step 225, the host and the USB peripheral communicate with each other, for example using a set of instructions conforming to the MMC-2 (MultiMedia Card) standard. This communication includes a response to enquiries from the host by the control program 111 according to the MMC-2 specification, including enumeration of the files and sub-directories in the root directory of the USB device.

In a step 230, in conjunction with the control program 111, the controller 110 informs the host station 150 of the presence of an autorun file 121 to be executed on the host station 150. Then, in a step 235, the control program 111 accesses the key K2, decrypts the autorun program file 121, and supplies the decrypted autorun program file 121 to the host 150. The name of the file 121 can be “Autorun.inf”, for example, and this file can be held in the memory component 120 of the device or USB peripheral. The host 150 executes the autorun file 121. This provides the autorun function.

In a step 250, the control program 111 is enumerated again or identified as another USB device with rewritable non-volatile memory, such as a USB flash memory, which provides access in write mode to the autorun program file 121. If it is enumerated again, the control program 111 is identified with hardware interface descriptors for the other USB devices that the controller 110 emulates. In this embodiment, the controller 110 emulates simultaneously a CD-ROM reader and a USB flash memory, the latter emulation enabling writing in the memory of the device 100.

From a step 255, the device 100 operates as a USB flash memory. Then, in a step 260, the autorun program 121, copied to the host station 150 and in the process of being executed, provides a man-machine interface that enables the user of the host station 150 to launch a step of updating the autorun file 121 in the USB key 100. Alternatively, in the step 260, the autorun program 121 copied to the host station 150 periodically launches a step of updating the autorun program 121.

After launching the update, in a step 265, the autorun program 121 sends an update request to a server 190 via the network 170. This request includes a serial number and the version of the autorun program 121, the serial number forming part of the run-time code of the autorun program 121. In a step 270, the server 190 receives the request and verifies if the rights associated with the serial number authorize it to send a new version. If so, the server 190 sends to the autorun program 121 copied to the host station 150 a version 121′ of the autorun program file 121. This version 121′ is an updated version encrypted and signed using a key K1 corresponding to the decrypting key K2, the key K1 being obtained from the serial number and preferably from a master key.

In a step 275, the autorun program 121 being executed in the station 150 by the processor unit 153 receives its new version in the form of the file of the autorun program 121′ and sends the control program 111 stored by the key 100 a command to write the updated file 121′ in the memory area of the USB key containing the file 121, the controller 110 here emulating a USB flash memory.

In a step 280, the control program 111 verifies the authenticity of the updated version 121′. For example, the control program verifies the cryptographic signature accompanying the updated version 121′, either with the key K2 or with some other key, and, in the event of positive verification, copies this updated version 121′ in place of the file 121.

From a step 285, the USB key 100 is ready to function with the new version of the autorun file 121′.

Note that, in the embodiment described above, the autorun program 121 and its updated version 121′ are stored in the device 100 in an encrypted form, decryption occurring each time this program is copied into the memory of the host station 150. Alternatively, the autorun program 121 and its updated version 121′ are stored in the device 100 in a decrypted form, only one decryption taking place before storage.

The control program 111 preferably gives no access in write mode to the memory space of the key 100 in which the autorun file 121 is stored on switching on the key 100, steps 210 and 220. Thus the autorun file 121 is accessible only in read mode when the key is switched on.

As shown in FIG. 2C, in a second embodiment of the method of the present invention, after the steps 205 to 235 (FIG. 2A), a step 287 identical to the step 260 is executed. In a step 289, before starting updating of the program 121, a predetermined initialization value is written in the rewritable non-volatile memory of the controller 110, in a memory area that the control program 111 reads when launched, before enumeration. This initialization value signifies that, the next time the device is started, it will have to be identified as a rewritable non-volatile memory, for example a USB flash memory, and not as a CD-ROM reader.

Then, in a step 291, the autorun program 121 executed in the host station 150 commands stopping of the device 100. In a step 293, the autorun program 121 executed in the host station 150 commands restarting of the device 100 (as if it were switched on again).

In a step 295, the control program 111 executed by the controller 110 reads the predetermined value and verifies it. In a step 297, the device 100 is enumerated and does not identify itself as a CD-ROM but as a USB flash memory. The steps 265 to 285 (FIG. 2B) then follow.

Note that this second embodiment, illustrated in FIG. 2C, is necessary for operating systems of the host stations 150 that do not support modification and/or re-enumeration of a CD-ROM type USB peripheral.

Alternatively, the identification as a flash memory (“USB flash drive”) can be replaced by an identification as another type of mass memory supporting write commands, for example a magnetic medium external memory.

As seen in FIGS. 3A and 3B, the flowchart of a third embodiment of the method of the present invention includes the steps 205 to 235 described with reference to FIG. 2A except for the fact that, after the step 210, in a step 315, the controller 110 executing the control program 111 determines if a reserved memory area includes a predetermined initialization value (or default value) or password. In the case of an initialization value, the next step is a step 320 during which the device 100 is enumerated and identified as a rewritable non-volatile memory, for example a USB flash memory. In the case of a password, the next step is a step 390.

It is assumed here that, in a step 360, the host station 150 stores a data processing application 151 launched by the user and a new version 121′ of the autorun file 121. Via the application 151, in the step 360, the user launches an update of the autorun file 121 to replace it by its new version 121′.

In a step 365, by means of a read instruction to the control program 111 of the controller 110, the application 151 reads the version of the autorun program 121 and determines if that version is different from the version of the autorun program 121′. If so, the program 151 launches updating of the autorun program file 121 and, to this end, displays on the display screen of the host station 150 an interface for entering a password. In a step 370 (FIG. 3B), the user enters a password using the keyboard of the host station 150.

Then, in a step 375, the application 151 sends a write request to the control program 111, emulating a USB flash drive, so that the control program 111 writes in the memory 120, on the one hand, the password, in the area reserved for the password, and, on the other hand, the updated version 121′, in another reserved area.

In a step 380, the application 151 stops the operation of the device 100. In a step 385, the application 151 restarts the device 100, for example by switching it on again. The control program 111 is then run in the step 210, reads the predetermined initialization value in the reserve memory area and, after the step 315, proceeds to the step 390 since a password is stored in the reserved memory area.

In a step 390, the control program 111 determines if the value stored in the memory area of the memory 120 reserved for the password matches a password stored in the memory area 122. The term “matches” can indicate simple equality, for example, or equality after encryption or decryption using the cryptography key K2.

If the passwords do not match, the key is disabled, for example by writing a value in a memory area of the controller 110 reserved for this purpose. If the passwords correspond, in a step 395, the control program 111 copies the updated version 121′ stored in a reserved memory area in place of the previous version of the autorun file 121 and copies the predetermined initialization value into the area reserved for the password.

Starting from a step 395, the USB key 100 is ready to function with the new version of the autorun file 121′ and proceeds to the step 210 (FIG. 3A).

FIG. 4 shows a portable electronic entity 400, here in the form of a USB key. In other embodiments (not shown) the portable electronic entity implementing the present invention is a memory card or a SIM card.

A host station 450, for example a personal computer or a mobile telephone, is adapted to receive the USB key 400 in a USB port (not shown).

The portable electronic entity 400 includes an interface 430, here a USB interface, and a rewritable non-volatile memory 420. This rewritable non-volatile memory 420 is an EEPROM or EPROM, for example. This memory 420 stores a program 410 and an autorun file 460 that includes a call to the program 410. The autorun file 460 is therefore loaded and executed in the host station 450 as soon as the USB key is inserted into the USB port of the host station 450.

This second particular embodiment of the portable electronic entity of the present invention can furthermore have the same functions as the first embodiment described above.

In the context of the present invention, a program adapted to be executed automatically in the host station 450 on connection of the portable electronic entity 400 to the host station 450 covers both an autorun program executed directly and an autorun program executed indirectly by virtue of the execution of another file, as shown in FIG. 4.

1. Portable electronic entity, including:
means for connecting said entity to a host station,
a memory storing a program adapted to be executed automatically in said host station on connection of said entity to said host station, and
secure means for modifying said program.

2. Portable electronic entity according to claim 1, wherein the connection means are adapted to provoke a first enumeration on connection of said entity to said host station, during which said entity is identified and emulates a read-only memory reader containing the file of said program and the secure means are adapted, in order to modify said program, to provoke a second enumeration, during which said entity is identified and emulates a rewritable non-volatile memory reader containing the file of said program.

3. Portable electronic entity according to claim 2, wherein the secure means are adapted, in order to modify said program, to provoke stopping and restarting of the operation of the entity before provoking the second enumeration.

4. Portable electronic entity according to claim 3, wherein the secure means are adapted to write into a reserved memory area of said entity an instruction provoking the identification of said entity as a rewritable non-volatile memory the next time said entity is started.

5. Portable electronic entity according to claim 4, wherein the connection means are adapted to provoke a first enumeration during which said entity is identified as a CD-ROM reader.

6. Portable electronic entity according to claim 2, wherein the secure means are adapted to provoke a second enumeration during which said entity is identified as a USB flash memory reader.

7. Portable electronic entity according to claim 1, wherein the secure means include means for authenticating a modified version of said program.

8. Portable electronic entity according to claim 7, wherein the secure means include means for verifying a signature of a modified version of said program.

9. Portable electronic entity according to claim 7, wherein the secure means include means for decrypting a modified version of said program.

10. Portable electronic entity according to claim 7, including a memory area storing a cryptographic key and wherein the secure means for modifying said program use a cryptographic key corresponding to said stored cryptographic key.

11. Portable electronic entity according to claim 1, wherein the autorun program includes means for accessing a remote server via a network.

12. Portable electronic entity according to claim 1, including a physical interface with the host station conforming to the USB specification, and adapted to communicate with the host station using a protocol conforming to the USB specification to obtain modification data of said program.

13. Method for updating an autorun program of a portable electronic entity, including:
a step of connecting said entity to a host station,
a step of executing in said host station a program stored by said entity and adapted to be executed automatically in said host station on connection of said entity to said host station, and
a step of secure modification of said program.

14. Method according to claim 13, wherein, during the connection step, a first enumeration is provoked during which said entity is identified and emulates a read-only memory reader containing the file of said program and, during the secure modification step, a second enumeration is provoked during which said entity is identified and emulates a rewritable non-volatile memory reader containing the file of said program.

15. Method according to claim 14, wherein, during the secure modification step, operation of the entity is stopped and restarted before provoking the second enumeration.

16. Method according to claim 15, wherein, during the secure modification step, there is written into a reserved memory area of said entity an instruction provoking the identification of said entity as a rewritable non-volatile memory the next time said entity is started.

17. Method according to claim 13, wherein, during the secure modification step, a modified version of said program is authenticated.

18. Method according to claim 17, wherein, during the secure modification step, a cryptographic key is used corresponding to a cryptographic key stored in said entity.

19. Method according to claim 13, wherein, during the secure modification step, a remote server is accessed via a network.

20. Autorun program of a portable electronic entity, including instructions for implementing the method according to claim 13.
